(19) United States
(12) Patent Application Publication
(10) Pub. No.: US 2005/0234948 A1
(43) Pub. Date: Oct. 20, 2005

(54) Method and model of the universe

(76) Inventor: James D. Ahrens, Oelwein, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/182,600

(22) Filed: Jul. 15, 2005

Related U.S. Application Data
(60) Provisional application No. 60/588,901, filed on Jul. 16, 2004.

(51) Int. Cl. G06F 17/00

(52) U.S. Cl. 707/100

(57) ABSTRACT

A computer-assisted method includes creating a model of a universe based on a plurality of assumptions and applying the model of the universe to solve a problem. The plurality of assumptions include: (a) in transiting a boundary of a black hole the field lines of the black hole reverse relative to the reference frame of the particle, (b) a quantum particle emerges from the black hole through an axial jet and emanates from a black hole; (c) field lines of the particle reverse and the particle changes into an anti-particle; (d) to maintain conservation of charge, there is a mirror universe, \overline{U}, of the universe, U; (f) both universes evolve identically; and (g) an inter-region, I, connects U and \overline{U}.

### PRIORITY STATEMENT

This application claims priority to U.S. Provisional Patent Application No. 60/588,901, filed Jul. 16, 2004, herein incorporated by reference in its entirety.

### BACKGROUND OF THE INVENTION

The present invention relates to a model and method of modeling. More particularly, but without limitation, the present invention provides for a method and system for modeling phenomenon associated with the universe, including black holes. The present invention provides a model consistent with numerous observable or identifiable phenomenon, including an explanation of dark matter, black holes, dark energy, matter/anti-matter paradox, information paradox, early structure formation in the universe, action at a distance.

The present invention draws together a number of diverse observations associated with various entities or effects in order to provide a model of the universe. The connection between these observations and between various entities and effects has not heretofore been made. The present invention is not, however, a complete model of the universe, but is nonetheless elegant and believed to be accurate in relating numerous features of the universe and believed to correct some of the inadequacies and errors in current quantum astrophysics and/or cosmology theories.

There are numerous theories regarding the universe and phenomenon related to the universe. These various theories may or may not be correct. Often one theory is discarded once there are observations inconsistent with the theory and a new theory is adopted. What is needed is a simple and consistent model of the universe.

### BRIEF SUMMARY OF THE INVENTION

Therefore, it is a primary object, feature, or advantage of the present invention to improve over the state of the art.

It is a further object, feature, or advantage of the present invention to provide a model of the universe which is consistent with observable phenomena.

It is a still further object, feature, or advantage of the present invention to provide a model of the universe which is elegant in design.

Yet another object, feature, or advantage of the present invention is to provide a model of the universe which is extendable.

A further object, feature, or advantage of the present invention is to provide a useful model that can be used in various types of analysis, computations, and predictions.

One or more of these and/or other objects, features, or advantages of the present invention will become apparent from the specification and claims that follow.

According to one aspect of the present invention a computer-assisted method includes creating a model of a universe based on a plurality of assumptions and applying the model of the universe to solve a problem. The first assumption is that in transiting a boundary of a black hole, the field lines of the boundary (when viewed from a reference point), reverse, and a particle emerges from the black hole through an axial jet. The second assumption is that the field lines of the particle itself reverse and it changes into its anti-particle. The third assumption is that to maintain conservation of charge, there has to be a mirror universe \overline{U} of the universe U and both of these universes evolve absolutely identically. The fourth assumption is that the evolution may be mediated through an inter-region, I, connecting U and \overline{U} and maintaining synchronization.

The model can be implied in various ways to solve different problems and different classes of problems. For example, the model can be applied to a system other than the universe, for example, an atomic or molecular system. Another way that the model can be applied is to determine a set of equations from the model and applying the set of equations to a physical problem. Of course, because the method is a computer-assisted method, the step of applying the model of the universe to solve the problem may include processing data associated with representations of objects within the universe and providing a physical output.

The present invention contemplates that additional assumptions may also be made. For example, the inter-region, I, can be assumed to comprise connections between particles in U and \overline{U}. These connections can be modeled to have a mass. These connections can be modeled as strings.

### BRIEF DESCRIPTION OF THE DRAWINGS

FIGS. 1A and 1B illustrates a geometric model according to a first and second assumption.

FIG. 2 illustrates a geometric model of a third assumption.

FIG. 3A illustrates one embodiment of an inter-region between U and \overline{U}.

FIG. 3B illustrates an alternative embodiment of an inter-region between U and \overline{U}.

FIG. 4A illustrates one embodiment of an inter-region, I, between U and \overline{U} with an example of connecting particles.

FIG. 4B illustrates another embodiment of an inter-region, I, between U and \overline{U} with an alternative example of connecting particles.

FIG. 5 illustrates one embodiment of applying the model to solve a problem.

FIG. 6 illustrates one embodiment of the model of the present invention applying the model to the problem of entanglement.

FIG. 7 is a block diagram of one embodiment of the present invention as implemented on a computer.

FIG. 8 is a diagram illustrating how one embodiment of a model of the universe of the present invention provides for advances for solving numerous problems.

### DETAILED DESCRIPTION OF THE PREFERRED EMBODIMENT

The present invention is directed to a model of the universe. The model of the present invention is computer implementable and provides insight to numerous observations and phenomenon. It is to be understood that the present invention is directed to a model or a method of modeling. Thus, even if assumptions made are inaccurate or incomplete as to the universe, the method and model remain useful. Much the same way as a children's physical model of the planetary system remains useful as a topic of discussion or educational tool despite not being to scale, not showing proper orbits, showing improper colorations, or otherwise being incorrect. Thus, incomplete, and even inaccurate models still have utility, particularly with respect to complex systems such as the universe.

Although the present invention is believed to have numerous applications, one of the applications of the present invention is to better understand black holes so that one can properly consider the problems of creating black holes prior to creating them. To derive this model of the universe, a set of assumptions were made based in part on consideration of black holes.

The first of these assumptions is that when a particle transits the boundary of a black hole, the field lines of the boundary (from a reference point) reverse and the particle emerges from the black hole through an axial jet emanating from a black hole into an unbounded region of space instead of traveling to the interior of a black hole. It is to be understood that the term “particle” is defined broadly and is intended to include photons.

The second assumption is that the field lines of the particle itself reverse and the particle changes into its anti-particle.

The third assumption is that in order to maintain conservation of charge, there has to be a mirror universe, \overline{U}, of our universe, U, and both of these universes evolve absolutely identically.

The fourth assumption is that this evolution is mediated through an inter-region, I, connecting U and \overline{U} and maintaining synchronization of U and \overline{U} to evolve identically as they are identical. Thus, random quantum fluctuations would be identical in both U and \overline{U}. Also, it should be understood that the model implies that particles can pass both ways across the boundary of a black hole. Essentially the inter-region, I, is what needs to be characterized.

In addition to these assumptions, other assumptions may be made and may be added to the model as appropriate. These assumptions were selected to explain various reported phenomena through application of a consistent model. Although, the model is generally explained in geometric terms to facilitate understanding, the model may also be presented through rigorous mathematical explanation.

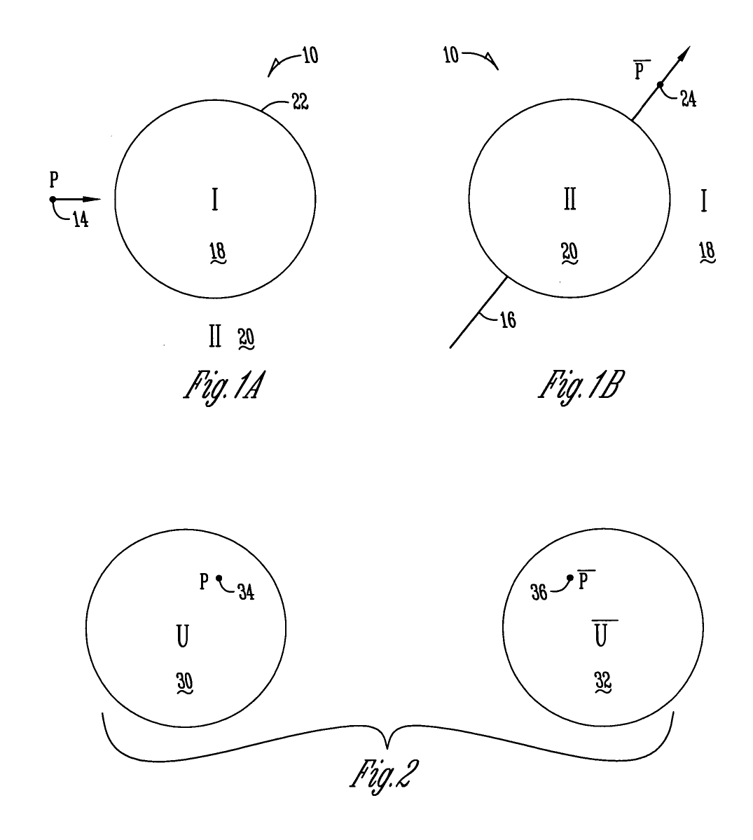

FIG. 1A illustrates a black hole 10 with an interior region 18 and an exterior region 20 separated by a boundary 22. There is a particle 14 approaching the boundary 22 of the black hole 10. The interior region 18 of FIG. 1A becomes the exterior region 18 of FIG. 1B. The particle exits the region 18 or FIG. 1A into the region 18 in FIG. 1B along an axis of rotation 16. The field lines associated with the particle 14 reverse, changing particle p into its anti-particle 24.

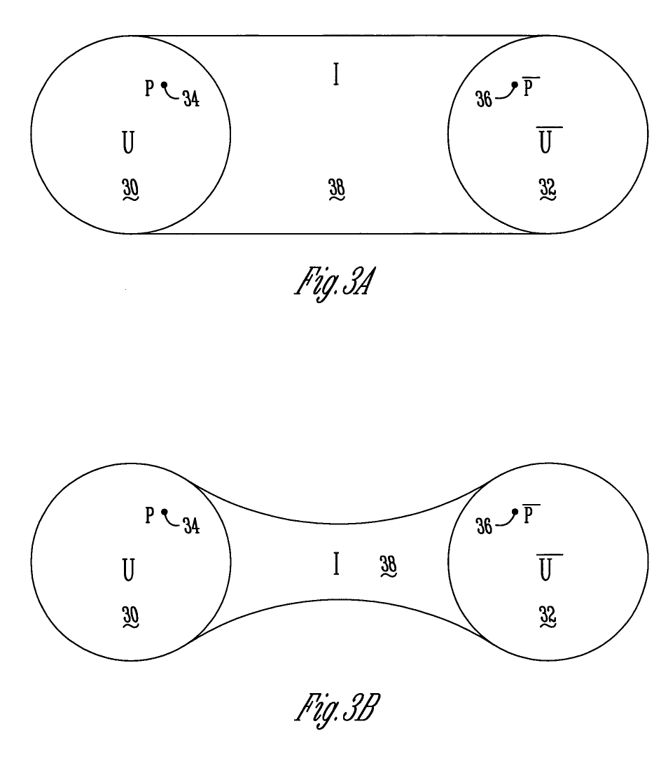

FIG. 2 illustrates a geometric version of the model illustrating a universe, U, (30) with a particle 34 within the universe 30. There is also an anti-universe, \overline{U} (32) with an anti-particle 36 within the anti-universe 32. The universe 30 and anti-universe 32 are mirror images of each other.

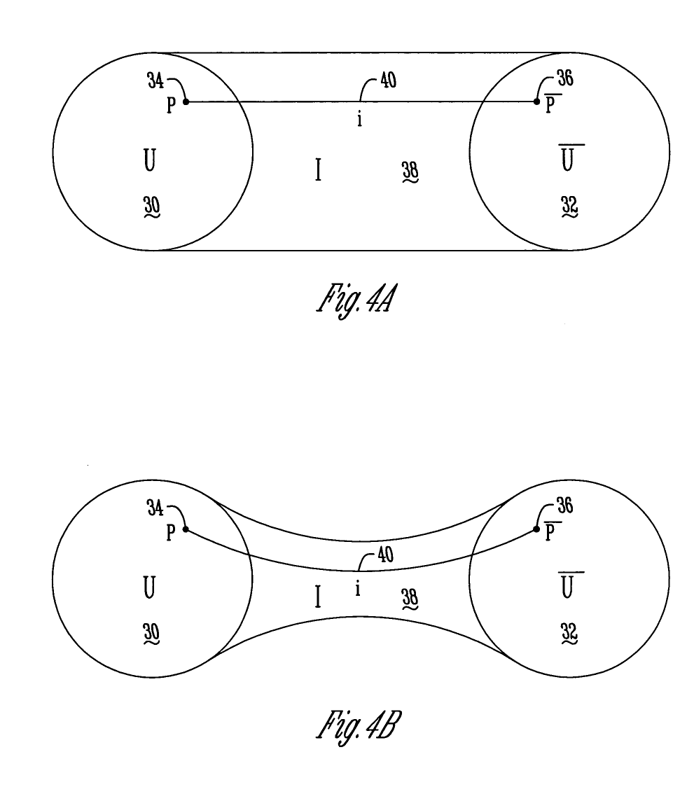

FIGS. 3A and 3B illustrate different geometries for an inter-region, I (38), between the universe, U (30), and the anti-universe, \overline{U} (32). The geometries shown are merely representative of the types of geometries that can be used to express a relationship between U and \overline{U}. Other geometries may be used as may be appropriate in a particular model or to solve a particular problem.

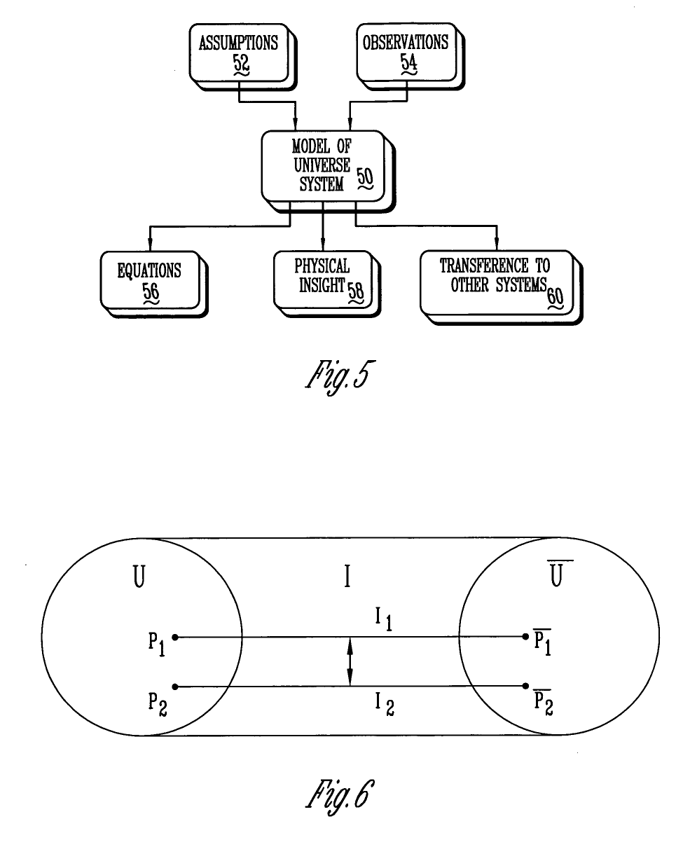

FIGS. 4A and 4B illustrate different embodiments where connecting particles, i, connect particles p and \overline{p}. The i (40) may be a representation of what is known as the Higgs Boson a hypothesized elementary particle.

FIG. 5 is an information flow diagram illustrating one embodiment of the present invention to illustrate how the model of the universe can be used. In FIG. 5, the model of the universe system 50 is shown. The model 50 is preferably implemented on a computer or other electronic device. Inputs to the model 50 include assumptions 52 such as the assumptions already discussed as well as alternative or additional assumptions. In addition, observations 54 can provide inputs into the model. The observations 54 provided may depend in part on the problem being solved.

The model 50 also preferably provides a number of different types of output. This can include equations 56, physical insight and principles 58, and transference of the model to other systems 60. The output of the model can be a physical output such as one that is displayed on a display, printed, or stored on a computer-readable medium.

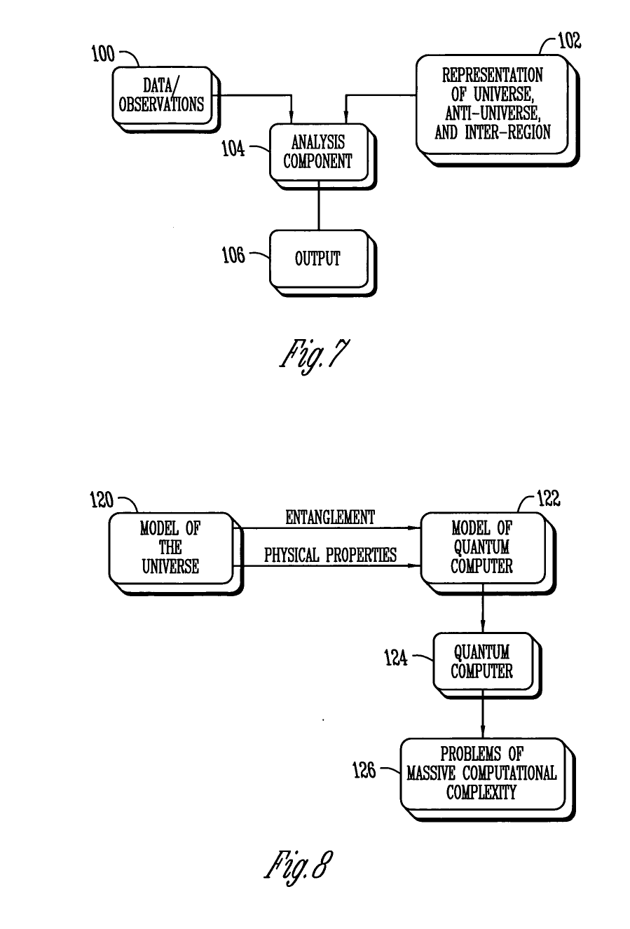

FIG. 6 illustrates one embodiment of the model of the present invention adapted to explain the phenomenon of action at a distance of entanglement. FIG. 6 is described later herein.

FIG. 7 is a block diagram of the present invention as can be implemented in software. In FIG. 7, there are data and/or observations 100 which are used as input to analysis component 104. In addition, there is a representation of the universe, anti-universe, and/or inter-region between the universe and the anti-universe 102 which also serves as an input to the analysis component 104. There is an output 106 from the analysis component 104. The output can be in printed form, displayed, or can be stored on a computer-readable medium or otherwise output. The analysis component 104 is adapted to take the data and/or observations 100 in combination with the representation of the universe, anti-universe, and/or inter-region between the universe and the anti-universe to provide the output. The analysis component can derive equations to fit the data/observations and the representation of the universe. The analysis component can be implemented in any number of ways, including genetic algorithms, neural networks, and other methodologies, depending in part upon the particular problem being addressed and the data and/or observations available.

FIG. 8 is a diagram illustrating how the model of the universe 120 of the present invention can be applied. For example, the present invention provides insight regarding entanglement and physical properties associated with entanglement. The application of the model to quantum entanglement is discussed below. The understanding that the present invention provides regarding quantum entanglement can in turn be applied to a model of a quantum computer 122. The model of the quantum computer 122 can be used in providing a quantum computer 124 which in turn can be applied to problems of massive computational complexity 126. This is merely one example of the benefits and advantages that flow from the present invention.

A quantum computer derived from application of the model of the present invention would provide a means for solving problems having a computational complexity far greater than what is currently available. The use of quantum computers would allow classes of problems to be solved which have not been approachable, let alone solvable with existing technologies. The ability to perform such complex computations will lead to advances in numerous and far-reaching fields. It should further be understood that genetic algorithms or similar approaches could be used in approaching these problems-approaches that are not computationally efficient could be practicable so that problems are easier to define.

Another application of the model of the universe is take the model of the universe system and apply it, when appropriate to a model of another type of system, including an atomic or molecular system. This application of the present invention is applicable through transference of one system to another or through concepts of duality. This application of the model can lead to an understanding of electron orbits, chemical reactions, fluid flow equations, magnetic and electric fields, or other applications.

It is to be understood that the model of the present invention can be applied to address numerous paradoxes and unanswered questions. Depending upon the particular problem being solved, different observations may be considered and additional assumptions may be added. Below a number of contradictions and unanswered questions regarding the universe are addressed by applying the model of the present invention. It should be understood that these serve merely as examples and the present invention is not to be limited to application to these particular problems. It is to be further understood that there are many possible explanations for each of these categories and the application or extension of the present model or an isomorphic version of the present model is not necessarily correct, but is useful.

Matter/Anti-Matter Paradox

This is the question as to why one type of matter is dominant in the universe rather than another. That is because when the universe forms, there is no imbalance of matter and anti-matter. What happens is the universe is like a wave. One part of the wave is above the x-axis, there is a nodal point, and the negative part of the wave is below the x-axis. They are both of equal magnitude, but one is positive and one is negative. One side is matter or predominantly matter while the other side is anti-matter or predominantly anti-matter in precisely equivalent amounts or proportions.

If there is an imbalance in the generation of matter and anti-matter on one side, it is duplicated on the other side. The matter and anti-matter combine and annihilate each other and the excess matter is left over. The same process occurs on the other side, only with the anti-matter. Thus, there is no matter/anti-matter paradox.

Information Paradox

The information paradox says that information cannot be destroyed. If information or matter is transferred across the boundary of a black hole under present theories, then the information is irretrievably lost. With the model of the present invention, the interior of a black hole and the exterior are linked through the axial jets. Therefore, there is no information paradox.

Black Holes

A black hole is generally considered to be an object that absorbs light and allows nothing to escape. The event horizon is a gravity field around a black hole where the space-time is bent to such an extent that light can not escape it. The event horizon creates a boundary in space that allows nothing to escape. Thus, an object entering the event horizon vanishes. A singularity is what is at the center of the black hole and considered to be an infinitely dense point. The model differs from these two widely accepted theories by allowing matter and energy to escape from within the black hole and by removing the singularity in a bounded region replacing it with a point at infinity in an unbounded region of space.

Dark Matter

Dark matter is matter which can not be detected. Dark matter is a model used to explain certain observed imbalances in the universe. The existence of dark matter is based on the basic principle that we can measure velocities in some region (i.e. a stellar region or a galactic region) and for the measured velocities, there has to be enough mass to stop the objects within the region from flying apart. Based on the velocity measurements, there is an amount of inferred mass that is greater than the mass of the objects that give off light. Thus, the existence of dark matter is inferred.

According to one embodiment of the present invention, the connecting particles in the inter-region, their associated antiparticle, or both are dark matter. Dark matter comprises a great percentage of the energy or matter in the universe. Dark matter is evident in the increased galactic spin of galaxies that cannot be accounted for by the total luminous matter we see and so many hypothesize that there is some other type of matter which they call dark matter which they cannot see. That is what I call the connecting particle. They do not know if it is associated with structure such as galaxies or if it pervades our universe. In my model it is uniquely associated with its corresponding particle in our universe and especially with concentrated mass in galaxies. That is why we see this effect. It is dark because it is in the inter-region and light does not transfer from our universe into the inter region and yet its energy is apparent in our universe.

Nature of Dark Energy

That which is called dark energy has recently been discovered in the measurements of the recessional velocities of Type Ia super nova. The brightness of these super nova is thought to be known. Therefore, their distance and their recessional velocities can be determined. If gravity is the only force acting on cosmic scales, then like a rubber band that is always pulling on matter, matter should be slowing down. What is found is that there is something counter balancing gravity and matter is actually accelerating rather than decelerating. This has been a great mystery that has just been recently found in the last 10 years. The model can answer this directly. If matter and energy, as it enters a black hole, goes to the center singularity which is what every theory says, then from the model we know that when we cross the event horizon, the center singularity goes to the point at infinity and the region becomes unbounded. In both reference frames matter and energy fall to the center. For the exterior reference frame \overline{U} this is the center singularity. For the interior reference frame U our universe is unbounded space and the center is the point at infinity. Gravity is actually pulling matter and accelerating it. The theories are true, it is just that the center is the point at infinity and matter is streaming off to infinity.

Source of High Energy Cosmic Rays

Theory cannot account for the energy levels of some cosmic rays. The model suggests that this energy comes from the change in potential energy as a particle falls through the boundary of a black hole into our universe either from the interior or from Hawking radiation at the boundary.

Another source may be the conversion of a high energy flux in a black hole jet into particles.

Source of Anti-Matter in Black Hole Jets

Such anti-matter has been observed by gamma radiation at specific frequencies indicative of matter anti-matter recombination and annihilation. This source of anti-matter is unaccounted for in present theories.

The model can address this through particle transfer across black hole boundaries and particle conversion to anti-particles upon crossing black hole boundaries.

Again, high energy flux in black hole jets may generate, in this case, anti-particles.

M87 Black Hole Jets With no Accretion Disk

M87 is a celestial object with jets yet with no apparent accretion disk. The jets of black holes have been thought to be created from the accretion disc formed by material spinning around the exterior of the black hole and then being gravitationally pulled toward the black hole and its angular momentum being transferred into linear velocity away from the poles. The particle transfer across the black hole boundaries applies again. Thus, the model of the present invention is useful for explaining M87.

Nature and Dynamics of Black Hole Interiors

Black hole interiors and their dynamics are unknown. But given U and \overline{U} are identical, this problem is immediately solved with application of the model of the present invention.

String Theory

String theory is a strong but not universally accepted theory of particle physics. If the superstring variant of string theory is true, it would require 10 dimensions. U and \overline{U} each have three spatial and one time dimension. Thus, this adds up to 8 dimensions. In addition I most likely has one spatial dimension and one time dimension. This would add up to a total of 10 dimensions which would be consistent with string theory.

Standard Model Extendable or Replaced by Stronger Theory (Possible Unified Theory)

The UI\overline{U} model with U≅\overline{U} imposes strong symmetries which strongly limits models and places strong conditions on derived equations. For example, x, y, z, t most likely will be interchangeable with \overline{x},\overline{y},\overline{z},\overline{t} with appropriate change of reference frame.

In addition i and tᵢ may also be interchangeable. These and such things as the association of the cosmological with the quantum as provided in the model of the present invention should lead to a much stronger theory, indeed, the unified field theory, if it exists.

Why There are two Electric Charges

Why are there two and only two electric charges? The model of the present invention provides an explanation. The fact that there are only two charges follows from the fact that there are two universes, U and \overline{U} related by inversion of a particular nature.

Why There are Three Families of Particles or Three Forces Other Than Gravity, Three Color Charges and What Accounts for the Phenomena of Oscillations

Why are there three families of particles, three color charges, or three forces other than gravity? This could be related to the partitioning of space into three parts, U, I, and \overline{U}. This model of the universe may also addresses color charge oscillations, and neutrino oscillations. Such oscillations in U may be related to a resonant oscillation across UI\overline{U} of a particle system, say pi\overline{p}.

Why do Elementary Particles Have Mass

This appears related to either region I or the pairing of particles in U and \overline{U}. The mass effect is related to dark matter which may be the region I. The Higgs field is theorized to confer mass and may be linked to inter-region I which lies outside U.

Does the Higgs Particle Exist, and if so, why has it not Been Observed

According to one embodiment of the present invention, the inter-connecting particle is the Higgs Boson. The Higgs Boson is a hypothetical particle that confers mass to particles in our universe through the Higgs field. This seems to correspond highly with the model of the present invention in that it is conferring mass through dark matter in galaxies. We are at present trying to build accelerators to create particles such as Higgs and there may be a good reason not to do this. It may be that if we create Higgs in our universe that both ends, rather than one end, would be in our universe and this may cause some type of phase transition in the local neighborhood of our universe, perhaps destroying our world. These are problems that theorists have asked themselves and have always discounted. Their rationale has been that what they can create in a particle accelerator will be created in nature. This may not be the case. This may be the reason why we see no advance civilizations in our universe. They may be destroying themselves at this particular point of technical capability.

Methods for Black Hole and Cosmic String Formation

Matter and anti-matter recombination between U and \overline{U} at the formation of the universe could have resulted in intense photon pressure and the inertial confinement of matter in U and \overline{U}. This confinement may have been intense enough to form black holes and cosmic strings. Phenomena such as optical lensing and the superposition of unusual spatial geometries may also have contributed to this formation.

Further, upon formation, a black hole may possibly be stretched into a cosmic string or strings and a cosmic string may have collapsed into a black hole or several black holes.

There is a class of masses for black holes that are unaccounted for by present theory. Inertial confinement mediated by matter anti-matter recombination could be the answer.

Explanation of Early Structure Formation in the Universe

There exists unexplained early structure in the universe. Either black holes or cosmic strings created at an early stage could account for this. In addition, order could be imposed by effects mediated through inter-region I.

Action at a Distance

FIG. 6 illustrates one embodiment of the model of the present invention adapted to explain the phenomenon of action at a distance of entanglement. Entanglement generally refers to the phenomenon in which the quantum states of two or more objects have to be described with reference to each other even though the individual objects are spatially separated. There are correlations between observable physical properties of the system, which are unexplainable by quantum mechanics. For example, measurements performed on one system appear to be instantaneously influencing other systems entangled with it, yet classical theory indicates that information can not be transmitted from one system to another at a rate faster than the speed of light. The model of the present invention can be used to model quantum entanglement. In FIG. 6, there is an interaction between P₁ and P₂ which is mediated through the inter-region I. In particular, transfer of effect faster than the speed of light may occur because phenomena are not restricted to moving solely within the universe. Instead, effect is mediated through inter-region I from the first position in the universe to the second position in the universe. Because this path is not within U, there is no movement faster than the speed of light within the universe.

Thus, the model of the universe of the present invention can be applied to quantum entanglement and associated applications and technologies including quantum computing, quantum cryptography, and quantum teleportation.

Is Inflation Theory Necessary

Inflation theory states that the universe undergoes a rapid expansion in part preserving structure introduced by quantum fluctuations. This preservation of structure may be accounted for by effects mediated through inter-region I making inflation unnecessary.

Beta Decay

Duality with black hole jet particle transfer may imply that electron emission of beta decay may be confined to occur along the spin axis. Or if emitted randomly to leave the internal structure along the spin axis.

Explanation of Entanglement

The present invention is believed to have far-reaching impact. The model of the universe of the present invention stems from a geometric model of the universe that is consistent with numerous phenomenon. The present invention contemplates that the geometry of the model of the universe can be used to derive equations. One skilled in the art being presented with the geometric models of the universe of the present invention would be capable of deriving such equations. The present invention contemplates that these equations relating to matter or energy can be applied to other systems, or sub systems within the universe, particularly as the principles of duality would suggest. The present invention is not limited to the particular manner in which these equations are applied or to the particular systems involved.

Quantum Fluctuations of Matter

There are three special cases regarding momentum when a particle falls into black hole. In the first case, the black hole has no spin. The addition of the particle adds angular momentum thereby defining the axis for the system. In a second case, the combined system has no spin, but the original black hole had spin so there is an apparent spin axis. In the third case, the combined black hole and particle have no angular momentum, but quantum fluctuations of the particle should create fluctuations of spin/no-spin.

Gamma-Ray Production

It is theorized that as stars collapse into black holes they emit intense gamma radiation along their spin axis. This is consistent with energy emission, along the axis of the black hole. If light rays changing orbit around a black hole emit particles, the dual implies particles (electrons and positrons) may emit radiation as they fall into the black hole. Further, a change of geodesic paths of a light wave in free space would emit virtual pairs and account for the quantum fluctuations of matter in free space.

Mass of the Universe

The model of the present invention also offers the opportunity to determine the total mass and energy content of the universe. This can be achieved by measuring the mass of a black hole say by analyzing the velocity of an object in its accretion disk. Then calculate the velocity of particles in the jet of the black hole arising from its interior (these must be differentiated from particles that some theorists believe come from the accretion disk). These values would then be related to the mass of the universe

It should also be apparent from the description given herein, that the present invention provides for numerous computer assisted methods for modeling the universe or subsystems within the universe and for applying a model of the universe. Thus either actual or theoretical data sets can be related to either the geometric model provided or equations derived from the geometric model for both testing the accuracy of the model or applying the model.

Of course, the model of the universe of the present invention could also lead to advances in superconductivity, gravitational waves analysis and generation, communication systems, lasers, time measurements, sensors, energy production/conversion/efficiency improvements, harnessing forces in new ways, anti-gravity devices, gravity shields, advances in computers, quantum computers, optical computers, and chaos computing.

It should further be understood that one of the advantages of the present invention is that it begins with a geometric model. A geometric model is generally more easily understood than an analytic model, is more easily verified as correct or useful, and can be applied more easily. It should be further understood that different additions or corrections may be made to the model as necessary. For example, it is unclear whether in forming a black hole, dimensions are added to the universe or dimensionality remains constant. These conditions when determined could add to the model.

One philosophical observation of the present invention is that many people believe in a divine being who is both omnipresent and capable of intervening in the universe without being seen or detected. One may wonder how this could be achieved without violating the laws of the universe. This belief is consistent with the UI\overline{U} model of the present invention if God exists in the inter-region, I, or is identical to the inter-region I. If so, then God could then be (1) everywhere or in contact with the entire universe, even at its smallest scales; (2) unseen by U and \overline{U}; (3) U and \overline{U} could be altered by a mediating effect through or from inter-region I.

Another embodiment of a model of the universe applies different assumptions. In this alternate model, black holes are assumed to be vortices of space itself and U and \overline{U} may in fact be directly connected and therefore the entire universe is just U.

The present invention provides for computer-assisted modeling of the universe through any means that would be known by one skilled in the art. For example the present invention contemplates use of any number of types of processors, computers and software such as may be appropriate in a particular environment or context. The present invention provides for the model to be used in conjunction with observable, collected or hypothetical data sets in order to provide interpretations of this data and to provide additional explanations of the data or to analyze relationships between the data. The present invention contemplates that additional components to the framework of modeling of the universe can be added or may be appropriate for a particular use.

1. A computer-assisted method, comprising:
creating a model of a universe based on a plurality of assumptions;
applying the model of the universe to solve a problem; and
wherein the plurality of assumptions include:
(a) in transiting a boundary of a first black hole, field lines of the first black hole reverse with respect to a reference frame of the particle;
(b) a quantum particle emerges from a second black hole through an axial jet and emanates from second black hole;
(c) field lines of the particle reverse and the particle changes into an anti-particle;
(d) to maintain conservation of charge, there is a mirror universe, \overline{U}, of the universe, U;
(e) both universes evolve identically; and
(f) an inter-region, I, connects U and \overline{U}.

2. The computer-assisted method of claim 1 wherein the step of creating a model is performed using a computer.

3. The computer-assisted method of claim 1 wherein the step of applying the model is performed using a computer.

4. The computer-assisted method of claim 1 wherein the step of applying the model is applying the model to a system other than the universe.

5. The computer-assisted method of claim 1 wherein the system other than the universe is a molecular or atomic system.

6. The computer-assisted method of claim 1 wherein the step of applying the model of the universe to solve a problem includes determining a set of equations from the model and applying the set of equations to a physical problem.

7. The method of claim 1 wherein the step of applying the model of the universe to solve the problem includes processing data associated with representations of objects within the universe and providing a physical output.

8. The method of claim 1 wherein the inter-region, I, comprises connections between particles in U and \overline{U}.

9. The method of claim 8 wherein the connections are modeled to have a mass or energy.

10. The method of claim 8 wherein the connections are modeled as strings.

11. The method of claim 1 wherein the problem is a quantum entanglement problem.

12. The method of claim 11 further comprising designing a quantum computer based on application of the model of the universe as applied to the quantum entanglement problem.

13. The method of claim 11 further comprising designing a communication system based on application of the model of the universe as applied to the quantum entanglement problem.

14. The method of claim 1 wherein the first black hole is in U and the second black hole is in \overline{U}.

15. The method of claim 1 wherein the inter-region, I, maintains synchronization between U and \overline{U}

16. A computer model of the universe, comprising:
a data representation of a universe, U;
a data representation of an anti-universe, \overline{U}, the anti-universe being a mirror image of the universe;
a data representation of an inter-region, I, between the universe and the anti-universe, wherein the inter-region connects the universe and the anti-universe and maintains synchronization between the universe and the anti-universe.

17. The computer model of claim 16 wherein the universe includes a data representation of at least one particle and the anti-universe includes a data representation of at least one corresponding anti-particle.

18. The computer model of claim 16 further comprising an input for receiving observations about the universe.

19. The computer model of claim 16 further comprising an analysis component.
